(19) United States
(12) Patent Application Publication
(10) Pub. No.: US 2014/0229162 A1
(43) Pub. Date: Aug. 14, 2014

(54) Determining Explanatoriness of Segments

(71) Applicant: HEWLETT- PACKARD DEVELOPMENT COMPANY, LP., Houston, TX (US)

(72) Inventors: Hyun Duk Kim, Palo Alto, CA (US); Maria G. Castellanos, Palo Alto, CA (US); Meichun Hsu, Palo Alto, CA (US); Cheng Xiang Zhai, Champaign, IL (US)

(73) Assignee: HEWLETT-PACKARD DEVELOPMENT COMPANY, LP., Houston, TX (US)

(21) Appl. No.: 13/766,019

(22) Filed: Feb. 13, 2013

(51) Int. Cl. G06F 17/28

(52) U.S. Cl. CPC G06F 17/28
USPC 704/9

(57) ABSTRACT

A technique may include generating a plurality of segments from sentences in a data set. The technique may further include determining the explanatoriness of each segment.

### RELATED APPLICATIONS

This application is related to U.S. patent application Ser. No. 13/485,730, entitled “Generation of Explanatory Summaries” by Kim et al., filed on May 31, 2012, which is hereby incorporated by reference in its entirety.

### BACKGROUND

A plethora of opinion information is often available for products, services, events, and the like. For example, with the advent of the Internet, web pages, ecommerce platforms, social media platforms, etc. have provided people with the ability to easily share their opinions. For instance, on many ecommerce sites, customers are often able to submit reviews and ratings regarding products they have purchased or services they have received. Additionally, people often share their opinion regarding a product or service via social media posts.

This opinion information may be collected for analysis. For example, a company selling a product may desire to know what customers are saying about the product. But reading through each opinion one by one can be a time-consuming, inefficient, and arduous task. While there are computer-aided techniques of determining the overall sentiment of reviews and ratings, it can be a challenge to determine the reasons behind the sentiments. However, knowledge of the multiple reasons underlying an opinion or sentiment may be very helpful to a company.

### BRIEF DESCRIPTION OF DRAWINGS

The following detailed description refers to the drawings, wherein:

FIG. 1 illustrates a method of computing an explanatoriness score for segments from a data set, according to an example.

FIG. 2(a) illustrates a method of generating candidate segments using a parse tree, according to an example.

FIG. 2(b) illustrates an example of a parse tree for generating candidate segments, according to an example.

FIG. 3 illustrates a method of generating an explanatory summa according to an example.

FIG. 4 illustrates a system for generating an explanatory summary, according to an example.

FIG. 5 illustrates a computer-readable medium for ranking segments by an explanatoriness score, according to an example.

### DETAILED DESCRIPTION

According to an example, a technique of generating an explanatory summary of a data set is provided. The terms “explanatory” and “explanatoriness” are used herein to denote that a text portion has been determined to provide an underlying reason or basis for an opinion. The technique can include generating a plurality of segments from sentences in a first data set. The first data set can include opinions of a particular character, such as opinions regarding a particular aspect of a product having a particular polarity. For instance, the first data set may include positive (an example of “polarity”) opinions regarding the touchscreen (an example of an “aspect”) of “Tablet Computer X”.

The generated segments can include at least some segments that are smaller than a sentence from which it was generated. The segments may be generated using a parse tree. The inventors have discovered that using a parse tree to identify segment boundaries may be beneficial because explanatory phrase boundary is likely to match with syntax boundary. Thus, instead of generating all possible subsequences as candidate segments, a smaller set of segments having proportionally a higher degree of explanatoriness may be generated.

The generated segments may be evaluated for explanatoriness. Evaluating the explanatoriness of each segment can include at least evaluating the discriminativeness of features of the respective segment by comparing features of the segment to a second data set. The second data set can be a data set of background information relative to the first data set. For example, the second data set can include all opinions regarding the product, regardless of aspect or polarity. For instance, the second data set may include both positive and negative opinions about Tablet Computer X, regardless of aspect. Accordingly, by making this comparison, it can be estimated whether each segment of the first data set contains unique information likely to relate to the reasons underlying the particular opinion associated with the first data set, such as the positive opinion of Tablet Computer X's touchscreen.

Each segment may be ranked based on the explanatoriness evaluation. Ranking may include sorting, assigning a numerical rank, or simply recognizing the explanatoriness evaluation of each segment. The segment having the highest rank may be selected for inclusion in an explanatory summary. Before segments are selected for inclusion, a redundancy check may be performed to ensure that the segment is not likely redundant to other segments already selected for inclusion in the summary. Additionally, after a highest ranked segment is selected, the selected segment may be removed from the first data set and the entire technique may be repeated. After a threshold has been met, the summary may be generated and output. As a result, an explanatory summary providing reasons for opinions of a particular character may be provided. Moreover, because the summary includes explanatory segments rather than entire sentences having explanatory portions, it may be more likely that all of the information in the summary is relevant.

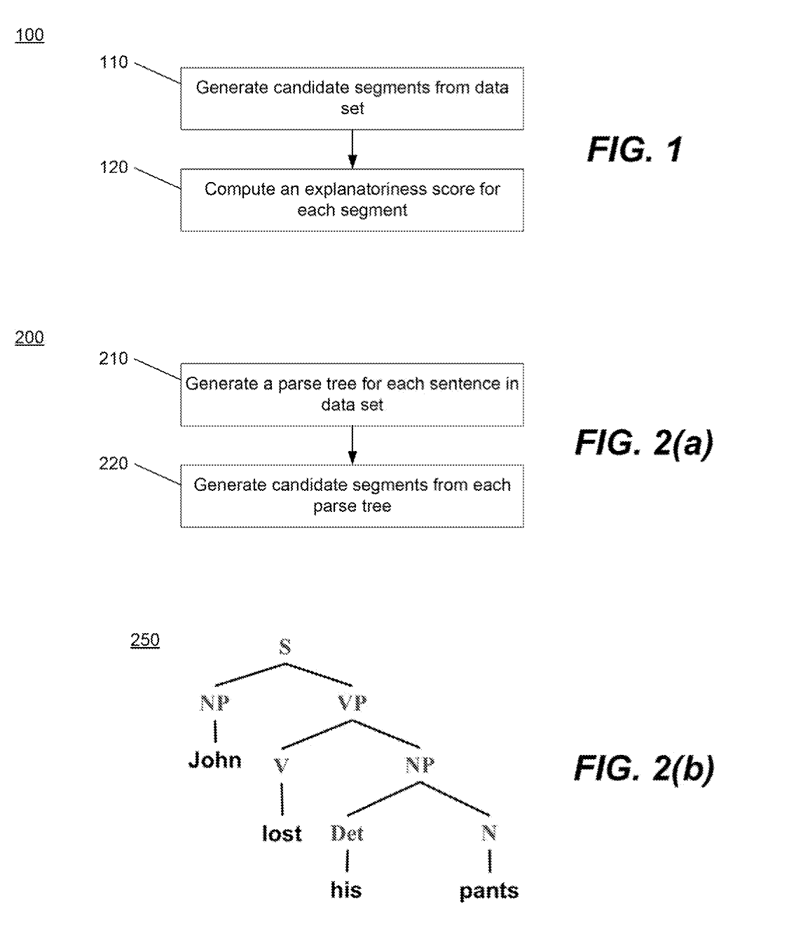

Referring now to the drawings, FIG. 1 illustrates a method of computing an explanatoriness score for segments from a data set, according to an example. Method 100 may be performed by a computing device, system, or computer, such as computing system 400 or computer 500. Computer-readable instructions for implementing method 100 may be stored on a computer readable storage medium. These instructions as stored on the medium may be called modules and may be executed by a computer.

Method 100 may begin at 110, where candidate segments may be generated from a data set (i.e., a first data set). The data set can include opinions, such as opinions regarding a product, service, event, person, or the like. Throughout this description, examples will be described in the context of opinions regarding a product. In addition, the data set may be limited to opinions having a particular character. For example, the opinions may relate to an aspect of a product and may have a particular polarity (e.g., positive, negative, or neutral). An “aspect” may include product features, functionality, components, or the like. For instance, the data set may include positive opinions regarding the touchscreen of “Tablet Computer X”. The opinions may be compiled from a variety of sources. For example, the opinions may be the result of customer reviews on an ecommerce website, articles on the Internet, or comments on a website.

The opinions may go through various pre-processing steps. For example, one of ordinary skill in the art may use various opinion mining techniques, systems, software programs, and the like, to process a large batch of opinion data. Such techniques may be used to cluster opinions into a variety of categories. For example, the opinions can be clustered by product if such clustering is not already inherent in the batch. The opinions may be further clustered as relating to particular aspects of the product. The opinions may be further clustered by polarity of the opinion. In some examples, the disclosed techniques may be part of an opinion analysis system or pipeline of processing performed on an opinion data set, such that the output of the opinion mining techniques are the input of the explanatory summary generation techniques.

The data set may include sentences. A sentence is used herein to denote a portion of text in the data set that, for purposes of the data set, is considered to be a single unit. For example, the data set may include text portions separated by some separator, such as a carriage return, a period, a comma, or the like. Such text portions would be considered the sentences of the data set. In one instance, the text portions may be grammatical sentences. In another instance, the text portions may be the entire review submitted by a user. The text portion may be defined by other boundaries as well, and may be dependent only on the structure of the data set.

The inventors have discovered that treating a data set's sentences as units (i.e., respecting the sentence boundaries established by or inherent in the data set) for purposes of determining explanatoriness has a number of potential disadvantages that could lead to a less useful explanatory summary. For example, a single sentence may have both relevant and irrelevant information. If the sentence receives a high explanatoriness score due to the relevant information, then the sentence may be included in the summary even though there is irrelevant information, which can decrease the quality and utility of the summary. On the other hand, if the sentence receives a lower explanatoriness score due to the irrelevant information, then the sentence may be excluded from the summary even though it has relevant information that would increase the quality and utility of the summary.

Accordingly, method 100 may generate candidate segments from the data set. The generated segments can include at least some segments that are smaller than a sentence from which it was generated. The segments may be generated using a parse tree. The inventors have determined that using a parse tree to identify segment boundaries may be beneficial because explanatory phrase boundary is likely to match with syntax boundary. Thus, instead of generating all possible subsequences as candidate segments, a smaller set of segments having proportionally a higher degree of explanatoriness may be generated.

Briefly turning to FIG. 2(a), a method 200 for generating candidate segments is shown, according to an example. At 210, a parse tree may be generated for each sentence in the data set. The parse tree may be a constituency-based parse tree. At 220, multiple candidate segments may be generated from the parse trees. For example, segments may be generated from individual leaf nodes and from subtrees of the parse trees.

FIG. 2(b) illustrates an example of a parse tree 250 for generating candidate segments, according to an example. A parse tree for the sentence “John lost his pants” is shown. This sentence is an example of a sentence that may be included in a data set. Method 200 can generate seven candidate segments from parse tree 250. In particular, method 200 can generate four one-word candidate segments from the leaf nodes: “John”, “lost”, “his”, and “pants”. Method 200 can generate two segments from subtrees: “his pants” and “lost his pants”. Method 200 can generate one segment corresponding to the entire sentence: “John lost his pants”. These segments, along with the rest of the segments generated from the other sentences in the data set, may then be evaluated for explanatoriness.

Turning back to FIG. 1, each segment may be evaluated for explanatoriness. For example, at 120 an explanatoriness score may be computed for each segment. Segments may be evaluated for explanatoriness in a variety of ways.

Two heuristics that may be helpful for evaluating explanatoriness are (1) popularity and (2) discriminativeness relative to background information. The popularity heuristic is based on the assumption that a segment is more likely explanatory if it includes more terms that occur frequently in all the segments in the data set. Popularity of a segment may be evaluated by comparing features of the segment with features of the first data set. “Features” is used in this context in the machine learning/classification sense. Accordingly, for example, features of the segment may be individual words or groups of words within the segment.

The discriminativeness heuristic is based on the assumption that a text segment with more discriminative terms that can distinguish the data set from background information is more likely explanatory. “Background information” is information from a second data set. The second data set can be a data set of background information relative to the first data set. For example, the second data set can include all opinions regarding the product, regardless of aspect or polarity. Indeed, the first data set may be a portion of the second data set (i.e., the second data set may be a superset of the first data set). For instance, the second data set may include both positive and negative opinions about any aspect of Tablet Computer X. Features of each segment may be compared to the features in the second data set to evaluate the discriminativeness of the segment. For example, it can be determined whether features of the segment occur with greater frequency in the first data set or the second data set. If the features occur with greater frequency or probability in the second data set (i.e., the background information), then it can be assumed that the segment is not very discriminative.

An implementation of these heuristics may include using a probabilistic model as a scoring function. In an example, two generative models may be created: one to model explanatory text segments and the other to model non-explanatory text segments. A given segment may be scored based on the probability that it has been generated by the explanatory model as opposed to the non-explanatory model. Using the first data set to estimate the explanatory model may enable the measurement of popularity of a given segment. Using the second data set to estimate the non-explanatory model may enable the measurement of discriminativeness of a given segment.

It may be assumed that a segment s=w₁ w₂ . . . wₙ can be either explanatory or not, denoted by Eε{0,1}. The explanatoriness of the text segment S can thus be scored based on the conditional probability p(E=1|s)=p(E=1|w₁ . . . wₙ), which can be interpreted as the probability that the text segment S is explanatory.

According to Bayes rule,

$$p ( E = 1 \vert {w}_{1} … {w}_{ n} ) = \frac{p ( {w}_{1} … {w}_{n} \vert E = 1 ) p ( E = 1 )}{p ( {w}_{1} … {w}_{n} )}$$

$$p ( E = 0 \vert {w}_{1} … {w}_{n} ) = \frac{p ( {w}_{1} … {w}_{n} \vert E = 0 ) p ( E = 0 )}{p ( {w}_{1} … {w}_{n} )} .$$

Since ranking text segments based on p(E=1|s) is equivalent to ranking them based on

$$\frac{p ( E = 1 \vert s )}{p ( E = 0 \vert s )} , \\ \frac{p ( E = 1 \vert s )}{p ( E = 0 \vert s )} = \frac{p ( {w}_{1} … {w}_{n} \vert E = 1 ) p ( E = 1 )}{p ( {w}_{1} … {w}_{ n} \vert E = 0 ) p ( E = 0 )} \\ ∝ \frac{p ( {w}_{1} … {w}_{n} \vert 1 )}{p ( {w}_{1} … {w}_{n} \vert E = 0 ) )} = {\prod }_{i = 1}^{n} \frac{p ( {w}_{i} \vert E = 1 )}{p ( {w}_{i} \vert E = 0 )} .$$

The general model of content of the segment (i.e., w₁ . . . wₙ) may be refined using a unigram language model and taking logarithm of both sides to obtain the following explanatoriness scoring function:

$${Score}_{E} ( s ) = {\sum }_{i = 1}^{n} log \frac{p ( {w}_{i} \vert E = 1 )}{p ( {w}_{i} \vert E = 0 )} .$$

p(wᵢ|E=1) and p(wᵢ|E=0) are the unigram probability parameters for word wᵢ in the explanatory and nonexplanatory content generative models, respectively. This scoring function may be referred to as the Segment Likelihood Ratio (SLR).

For estimating p(w|E=1) and p(w|E=0), without additional knowledge, it may be assumed that the set of text segments to be summarized O (i.e., the first data set) can be used as an approximate sample of words that are explanatory. Accordingly, O may be used to approximate the explanatory source. Likewise, a background data set T (i.e., the second data set) can be used to approximate the nonexplanatory source. This assumption also corresponds with the basic heuristics about explanatoriness described above. That is, discriminative content is popular in O, but not in T.

As one example, with maximum likelihood estimate, we have the following:

$$p ( w \vert E = 1 ) = \frac{c ( w , O )}{\vert O \vert} , p ( w \vert E = 0 ) = \frac{c ( w , T )}{\vert T \vert}$$

where c(w,O) is the count of word w in the set O. Variations of maximum likelihood or other methods of estimation may be used to estimate p(w|E=1) and p(w|E=0), as well.

Additional details regarding evaluating and scoring explanatoriness may be found in U.S. patent application Ser. No. 13/485,730, entitled “Generation of Explanatory Summaries” by Kim et al., filed on May 31, 2012, which has been incorporated by reference.

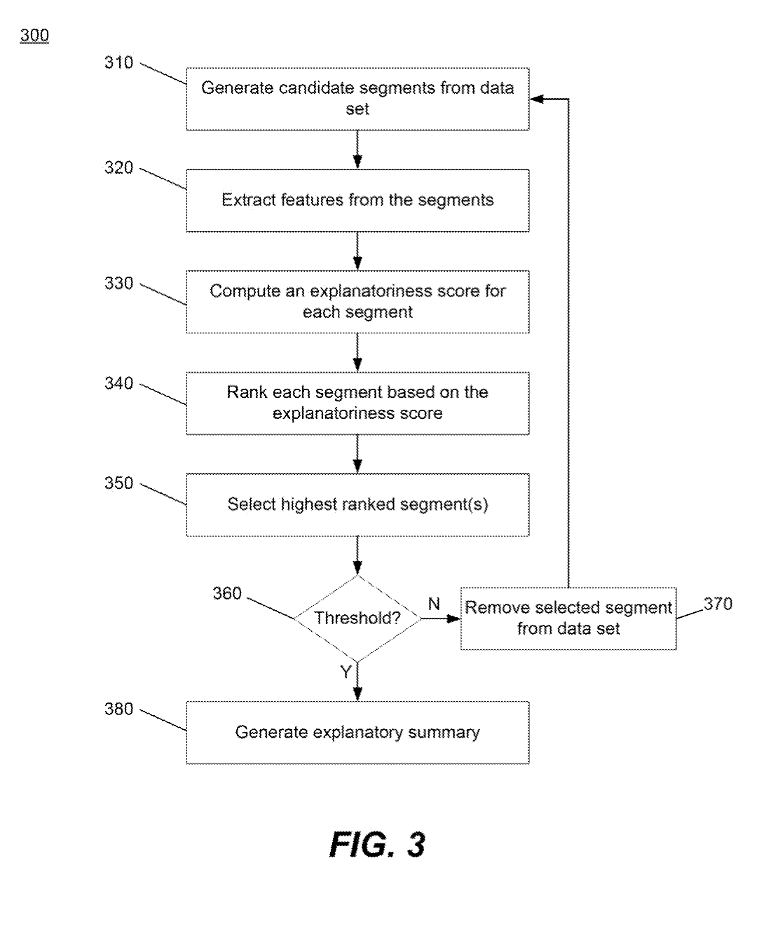

FIG. 3 illustrates a method of generating an explanatory summary, according to an example. Method 300 may be performed by a computing device, system, or computer, such as computing system 400 or computer 500. Computer-readable instructions for implementing method 100 may be stored on a computer readable storage medium. These instructions as stored on the medium may be called modules and may be executed by a computer.

At 310, candidate segments may be generated, similar to 110 of method 100. At 320, features may be extracted from the segments. The features may be extracted according to various machine learning or classification techniques. In one example, the features are individual words and groups of words in the segment. At 330, an explanatoriness score may be computed for each segment, similar to 120 of method 100.

At 340, each segment may be ranked based on its respective explanatoriness score. A segment with a higher explanatoriness score can be ranked higher than a segment with a lower explanatoriness score. Ranking may include various things, such as sorting the segments based on the explanatoriness scores, assigning a priority to each segment based on its explanatorines score, or simply scanning the explanatoriness scores and keeping track of the highest score along with an indication of the corresponding segment.

At 350, the highest ranked segment may be selected for inclusion in the explanatory summary. The segment may be immediately added to the summary or it may be added at a later time. In some examples, before a segment is selected for inclusion in the explanatory summary, the segment may be compared to previously selected segments to ensure that the segment is not redundant to the previously selected segments. The comparison may include comparing features of the segments.

At 360, it can be determined whether a threshold has been met. The threshold may be measured in various ways. For example, the threshold may be a specified number of segments or a specified number of total words. Alternatively, the threshold may be a minimum explanatory score. For instance, it may be decided that regardless of how many segments have been selected for inclusion in the explanatory summary, method 300 should stop when the explanatory scores of the segments drop below a certain value.

If the threshold has been met (“Y” at 360), method 300 may proceed to 380 where the explanatory summary is generated. Generation of the explanatory summary may include adding the selected segments to the summary in a readable fashion. For example, the segments may be numbered or separated by one or more of various separators, such as commas, periods, carriage returns, or the like. The summary may additionally be output, such as to a user via a display device, printer, email program, or the like.

If the threshold has not been met (“N” at 360), method 300 may proceed to 370 where the selected segment is removed from the data set. Method 300 may then proceed to 310, where new candidate segments may be generated from the modified data set (i.e., the data set with the previously selected segment removed therefrom). Removing the selected segment may be beneficial as the presence of that segment may have affected the explanatoriness scores of various other segments within the data set. Accordingly, more accurate results may be obtained by removing the selected segment during each iteration.

Various modifications may be made to method 100 and 300 by those having ordinary skill in the art. For example, block 350 may be modified to select a certain number of highest ranked segments rather than just a single segment. In another example, method 300 may proceed to block 350 if the threshold is not met. Various other modifications may be made as well and still be within the scope of the disclosure.

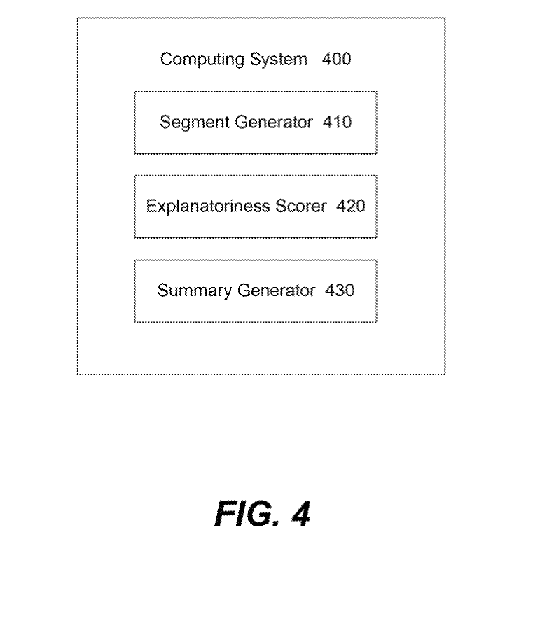

FIG. 4 illustrates a system for generating an explanatory summary, according to an example. Computing system 400 may include and/or be implemented by one or more computers. For example, the computers may be server computers, workstation computers, desktop computers, or the like. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, computing system 100 may include one or more machine-readable storage media separate from the one or more controllers.

Computing system 400 may include segment generator 410, explanatoriness scorer 420, and summary generator 430. Each of these components may be implemented by a single computer or multiple computers. The components may include software modules, one or more machine-readable media for storing the software modules, and one or more processors for executing the software modules. A software module may be a computer program comprising machine-executable instructions.

In addition, users of computing system 400 may interact with computing system 400 through one or more other computers, which may or may not be considered part of computing system 400. As an example, a user may interact with system 400 via a computer application residing on system 400 or on another computer, such as a desktop computer, workstation computer, tablet computer, or the like. The computer application can include a user interface.

Computer system 400 may perform methods 100 and 300, and components 410-430 may be configured to perform various portions of methods 100 and 300. Additionally, the functionality implemented components 410-430 may be part of a larger software platform, system, application, or the like. For example, these components may be part of a data analysis system.

Segment generator 410 may be configured to generate a parse tree for each sentence in a first data set. Segment generator 410 may be further configured to generate a plurality of segments from the parse trees. Explanatoriness scorer 420 may be configured to generate an explanatoriness score of each segment based on an explanatoriness evaluation. The explanatoriness evaluation may include comparing words in each segment to words in a second data set. Summary generator 430 may be configured to generate a summary of the first data set based on the explanatoriness scores. The summary may include only a subset of the segments.

In an example, the second data set may include customer reviews of a product or service. System 400 may also include an opinion miner to identify clusters in the second data set relating to different opinions about the product or service. The first data set may correspond to one of the identified clusters.

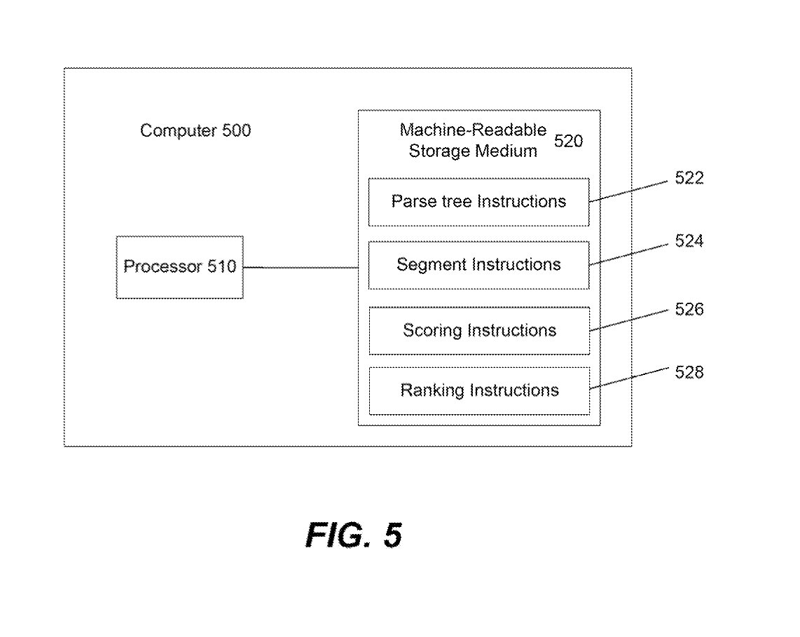

FIG. 5 illustrates a computer-readable medium for ranking segments by an explanatoriness score, according to an example. Computer 500 may be any of a variety of computing devices or systems, such as described with respect to computing system 400.

Processor 510 may be at least one central processing unit (CPU), at least one semiconductor-based microprocessor, other hardware devices or processing elements suitable to retrieve and execute instructions stored in machine-readable storage medium 520, or combinations thereof. Processor 510 can include single or multiple cores on a chip, multiple cores across multiple chips, multiple cores across multiple devices, or combinations thereof. Processor 510 may fetch, decode, and execute instructions 522, 524, 526, 528 among others, to implement various processing. As an alternative or in addition to retrieving and executing instructions, processor 510 may include at least one integrated circuit (IC), other control logic, other electronic circuits, or combinations thereof that include a number of electronic components for performing the functionality of instructions 522, 524, 526, 528. Accordingly, processor 510 may be implemented across multiple processing units and instructions 522, 524, 526, 528 may be implemented by different processing units in different areas of computer 500.

Machine-readable storage medium 520 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 520 can be computer-readable and non-transitory. Machine-readable storage medium 520 may be encoded with a series of executable instructions for managing processing elements.

The instructions 522, 524, 526, 528 when executed by processor 510 (e.g., via one processing element or multiple processing elements of the processor) can cause processor 510 to perform processes, for example, methods 100, 300, and variations thereof. Furthermore, computer 500 may be similar to computing system 400 and may have similar functionality and be used in similar ways, as described above. For example, parse tree instructions 522 may cause processor 510 to generate a parse tree for each sentence in a data set. The data set may be related to an opinion. Segment instructions 524 may cause processor 510 to generate a plurality of segments from the parse trees. At least some of the segments may be shorter than a sentence from which they were generated. Scoring instructions 526 may cause processor 510 to determine an explanatoriness score for each segment. The explanatoriness score may indicate likelihood that the respective segment describes a reason for the opinion. Ranking instructions 528 may cause processor 510 to rank the plurality of segments according to their explanatoriness scores. Machine-readable storage medium 520 may also include instructions to cause processor 510 to generate an explanatory summary of the opinion that includes the top N ranked segments, where N is a limit. N may be less than the total number of segments. The resultant summary may include the top ranked explanatory segments, some of which may be shorter than the sentences from which they were derived.

What is claimed is:

1. A method, comprising:
generating a plurality of segments from sentences in a first data set, the plurality of segments including at least some segments that are smaller than a sentence from which it was generated; and
evaluating explanatoriness of each segment, wherein evaluating the explanatoriness of each segment includes at least evaluating the discriminativeness of features of the respective segment by comparing the features to a second data set.

2. The method of claim 1, wherein the plurality of segments are generated from the sentences in the first data set using a parse tree.

3. The method of claim 1, further comprising generating a constituency-based parse tree for each sentence in the first data set, wherein multiple segments are generated from each constituency-based parse tree.

4. The method of claim 3, wherein segments are generated from individual leaf nodes and from subtrees of each constituency-based parse tree.

5. The method of claim 1, wherein the step of evaluating the discriminativeness of the features of the respective segment by comparing the respective segment to a second data set includes the step of, for each feature, determining whether the feature occurs with greater frequency in the second data set than in the first data set.

6. The method of claim 5, wherein the first data set is a portion of the second data set.

7. The method of claim 5, wherein the first data set includes opinion data regarding an aspect of a product or service and the second data set includes opinion data regarding the product or service.

8. The method of claim 1, wherein the evaluation step further includes evaluating the popularity of each feature.

9. The method of claim 1, further comprising ranking each segment based on the explanatoriness evaluation.

10. The method of claim 9, further comprising generating an explanatory summary by selecting the top N ranked segments, wherein N is a limit.

11. The method of claim 10, wherein before a segment is selected for inclusion in the explanatory summary, the segment is compared to previously selected segments to ensure that the segment is not redundant to the previously selected segments.

12. A system, comprising:
a segment generator to generate a parse tree for each sentence in a first data set and generate a plurality of segments from the parse trees;
an explanatoriness scorer to generate an explanatoriness score of each segment based on an explanatoriness evaluation, the explanatoriness evaluation including comparing words in each segment to words in a second data set; and
a summary generator to generate a summary of the first data set based on the explanatoriness scores, the summary including a subset of the plurality of segments.

13. The system of claim 12, wherein the second data set comprises customer reviews of a product or service, the system further comprising an opinion miner to identify clusters in the second data set relating to different opinions about the product or service, the first data set corresponding to an identified cluster.

14. A non-transitory computer readable storage medium storing instructions that, when executed by a processor, cause a computer to:
generate a parse tree for each sentence in a data set, the data set related to an opinion;
generate a plurality of segments from the parse trees, wherein at least some of the segments are shorter than a sentence from which they were generated;
determine an explanatoriness score for each segment, the explanatoriness score indicating a likelihood that the respective segment describes a reason for the opinion; and
rank the plurality of segments according to their explanatoriness scores.

15. The storage medium of claim 14, further storing instructions that, when executed by the processor, cause the computer to generate an explanatory summary of the opinion that includes the top N ranked segments, wherein N is less than the total number of segments.
